(19) United States
(12) Patent Application Publication
(10) Pub. No.: US 2013/0081234 A1
(43) Pub. Date: Apr. 4, 2013

(54) LEVER CLAMP AND USE THEREOF

(71) Applicants: Merle Seely, Drayton Valley (CA); Nolin Seely, Drayton Valley (CA)

(72) Inventors: Merle Seely, Drayton Valley (CA); Nolin Seely, Drayton Valley (CA)

(21) Appl. No.: 13/627,821

(22) Filed: Sep. 26, 2012

Related U.S. Application Data
(60) Provisional application No. 61/539,367, filed on Sep. 26, 2011.

(51) Int. Cl. B25B 5/04; B25B 5/10

(52) U.S. Cl. CPC B25B 5/04; B25B 5/101
USPC 24/514

(57) ABSTRACT

A lever clamp for use in securing liner to a liquid holding tank is provided. More specifically, the present clamp comprises a lever member pivotally connected to the clamp capable engaging a base bar and creating a clamping for to secure the liner to the tank.

### TECHNICAL FIELD

A lever clamp for securing lining, such as plastic lining, to the wall of liquid holding tanks, and use thereof, is provided.

### BACKGROUND

Industrial holding tanks used to contain and transport liquid are often lined with non-permanent plastic liners, or the like. For example, in the oil and gas industry, open-topped circular tanks can be used to contain and transport the large quantities of liquid used in fracturing operations. Typically, the tank is shipped to the fracturing site as semi-circular steel panels, which are then assembled together into a circular tank forming sidewalls having an upper edge.

Once assembled, the tanks can then be lined with a temporary liner. The liner, which can be made of polyethylene, is positioned within the circular tank and draped over the upper edges of the sidewalls. Due to the size of the tanks, large equipment, such as a backhoe, may be used to lift and move the liner into position within the tank.

Clamps can then be used to secure the liner in place over the edges of the sidewall, thereby preventing liquid from spilling over the edges or into the tank (e.g. behind the liner). Due to the size of the tanks and the liner, many clamps may be required. For example, where a tank is 102 feet in diameter and 12 feet in height, up to 50 clamps may be used to secure the liner in place.

Various common clamps have been used to secure tank liners. Having regard to FIG. 1A, one such prior art clamp 200 comprises at least two spaced apart C-shaped members 202, each member 202 having a threadable bolt 208 permanently affixed to a flat, steel, press bar 204. In operation, each bolt 208 can be simultaneously threaded to secure the press bar 204 in position over a liner (not shown) on a tank 100.

Because each bolt 208 is permanently affixed to the press bar 204, the bolts 208 can only be advanced in small increments relative to each other, at approximately the same rate, until the press bar 204 (which does not bend readily) clamps the liner in place. As a result, problems arise. For instance, the clamps 200 are difficult to install because they can require one worker to hold the clamp 200 and the liner in place on the tank while another worker operates a screwdriver to tighten each bolt 208 and accurately lower the press bar 204 into position. Tightening of the bolts must be synchronized in order to prevent bending of, or strain on, the press bar 204, and to prevent damage to the liner. Connections between each bolt 208 and the press bar 204 can easily become broken, resulting in a complete failure of the clamp 200. Similar difficulties also arise during removal of the clamp 200 given that each bolt 208 must be unthreaded in order to remove the press bar 204.

Proper alignment and positioning of known clamps can be arduous because it is not known whether the clamp 200 will be operable (i.e. secure the liner in place) until each bolt 208 has been threaded and the press bar 204 clamps the sidewall of the tank 100. Should the clamp 200 be misaligned or positioned incorrectly, each bolt 208 must be unthreaded simultaneously to remove the press bar 204 for repositioning. Inaccurate positioning of the clamp 200 can result in areas of weakened clamping force along the longitudinal axis of the press bar 204, resulting in the displacement of the liner at certain points or even a complete disconnection of the clamp 200 from the tank 100.

Indeed, it is known that where clamps are not properly installed, wind blowing against the clamp can cause it to become separated from the tank. Not only does this potentially cause the liner to leak, but often the clamp falls inwardly into the tank resulting in damages or holes in the liner. If a tear occurs after the tank has been filled, then the tank must be completely emptied before the liner can be removed and replaced. This is costly in terms of both time and money.

There is a need for an improved clamp capable of accurately and consistently securing a liner to a liquid holding tank.

### SUMMARY

A lever clamp and method of using same for securing a liner to a tank is provided. More specifically, a clamp having a pivoting lever member and use thereof is provided.

The present lever clamp and use of same for securing a liner to a liquid holding tank, may comprise at least one C-shaped member, capable of slidably receiving the liner and the tank, and having:
a. a lever member, pivotally connected to the at least one C-shaped member,
b. a base bar, in spaced relation and corresponding with the lever member, and
c. a bolt capable of releasably engaging the lever member to create a clamping force between the lever member and the base bar, and capable of securing the liner and the tank positioned therebetween.

In one embodiment, the present claim may comprise a plurality of C-shaped member positioned in sequence. Each C-shaped member may comprise a bolt, and each bolt may be capable of releasably engaging the lever member independently from one another.

### BRIEF DESCRIPTION OF THE DRAWINGS

FIG. 1A is perspective top view of a prior art clamp;

FIG. 1B is a perspective top view of the present lever clamp;

FIG. 2 is a perspective bottom view of the present lever clamp showing the lever member in an open position;

FIG. 3 is a perspective bottom view of the present lever clamp showing the lever arm in a closed position;

FIG. 4 is a side view of the present lever clamp in an open position; and

FIG. 5 is a side view of the present lever clamp in a closed position.

### DETAILED DESCRIPTION OF EMBODIMENTS

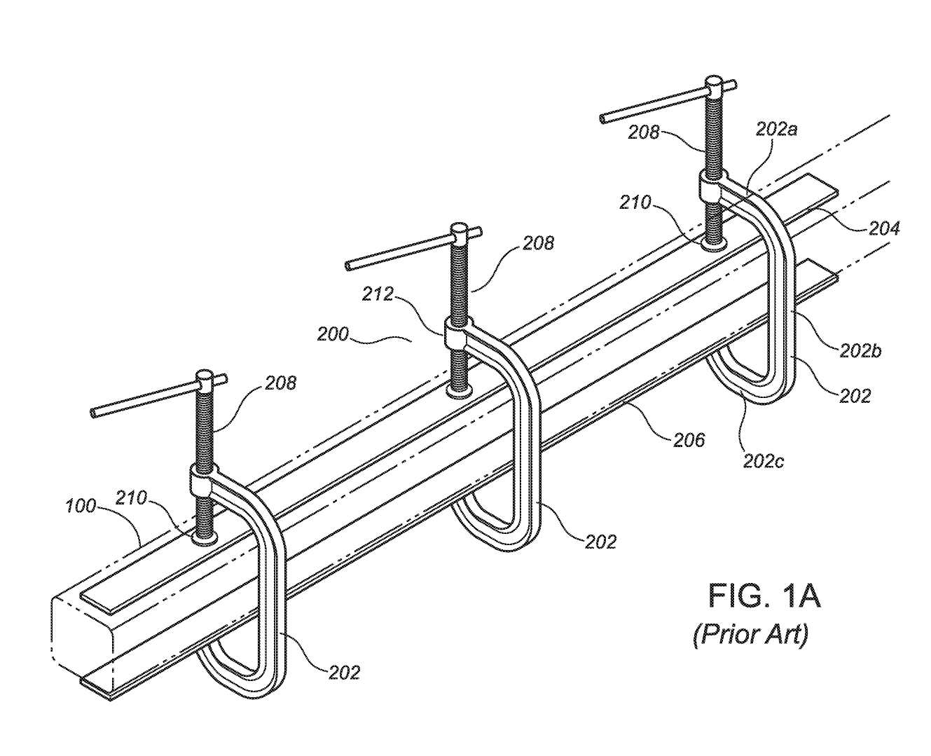

The present lever clamp 10 and method of using same will now be described having regard to the FIGS. 1b-5.

By way of background, FIG. 1A shows a prior art clamp 200 having at least two C-shaped members 202, each forming an upper end 202a, a middle portion 202b, and a lower end 202c. Each C-shaped member 202 further comprises a bolt 208 threaded through its upper end 202a, and securely connected to a press bar 204. In one embodiment, each threaded bolt 204 is secured to press bar 204 via a swivel member 210, or the like, which allows the threaded bolt 208 to turn within it as it advances through bore 212 in the upper end 202a of the C-shaped member 202. Prior art clamp 200 further comprises a base bar 206, connected to the lower end 202c of the C-shaped member 202, and corresponding to press bar 204.

In operation, prior art clamp 200 is positioned on the tank 100 having the liner (not shown) in place and bolts 208 are each advanced incrementally so as to keep the press bar 204 substantially flat along its longitudinal axis. Press bar 204 and corresponding base bar 206 create a clamping force on the tank 100, thereby holding the clamp 200 and liner in place.

Press bar 204 must be significantly advanced (and closed towards base bar 206) before it can be determined whether the prior art clamp 200 is correctly positioned on the tank 100. When correct positioning is not achieved, the threaded bolts 208 of the prior art clamp 200 must be incrementally retracted, the clamp repositioned and then the bolts 208 incrementally advanced. Similarly, when removing the prior art clamp 200, the bolts 208 must be incrementally retracted so as to keep prevent twisting of, or strain on, the press bar 204 and breaking of the connection between the swivel 210 and the bolt 208.

FIG. 1B shows one embodiment of the present lever clamp 10. Lever clamp 10 may comprise at least one C-shaped member 12. Each C-shaped member 12 may form an upper end 12a, a middle portion 12b, and a lower end 12c. Each C-shaped member 12 may further comprise a bar 18 for securing the clamp 10 to the tank 100. For instance, bar 18 may comprise a bolt threadably extending through a bore 19 of the upper end 12a of the C-shaped member 12. It is understood that although the term “bar” and “bolt” are used herein, any equivalent attachment means such as, for example, a pin, rod or screw be used.

The present clamp 10 may comprise a lever member comprising the combination of an arm 13 and a press bar 14 extending therefrom. Arm 13 may be pivotally connected to the middle portion 12b of the C-shaped member 12. Collectively, the lever member may be positioned in spaced relation and corresponding to a base bar 16, and be operative to create a clamping force therewith when positioned on the tank 100. Base bar 16 may be connected to the lower end 12c of the C-shaped member.

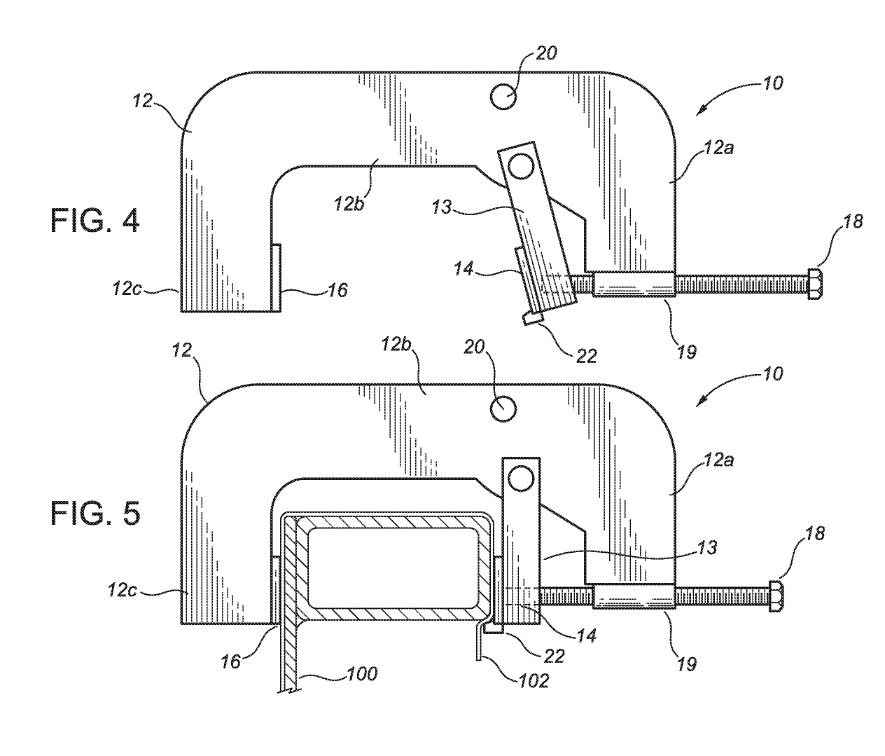

In operation, tank 100 (e.g., see tank 100 in FIG. 5) may be received between press bar 14 and base bar 16. Bolt 18 may then be threaded through bore 19 to engage press bar 14 and to close same against base bar 16, thereby creating a clamping force against tank 100.

The present lever clamp may provide that bolt 18 be threaded through bore 19, independently from movement of the press bar 14, to secure or unsecure the lever member against the tank 100. The present clamp 10 may therefore reduce twisting or bending forces on the press bar 14 and enable adjustable and consistent clamping forces along the longitudinal axis of bar 14 against tank 100.

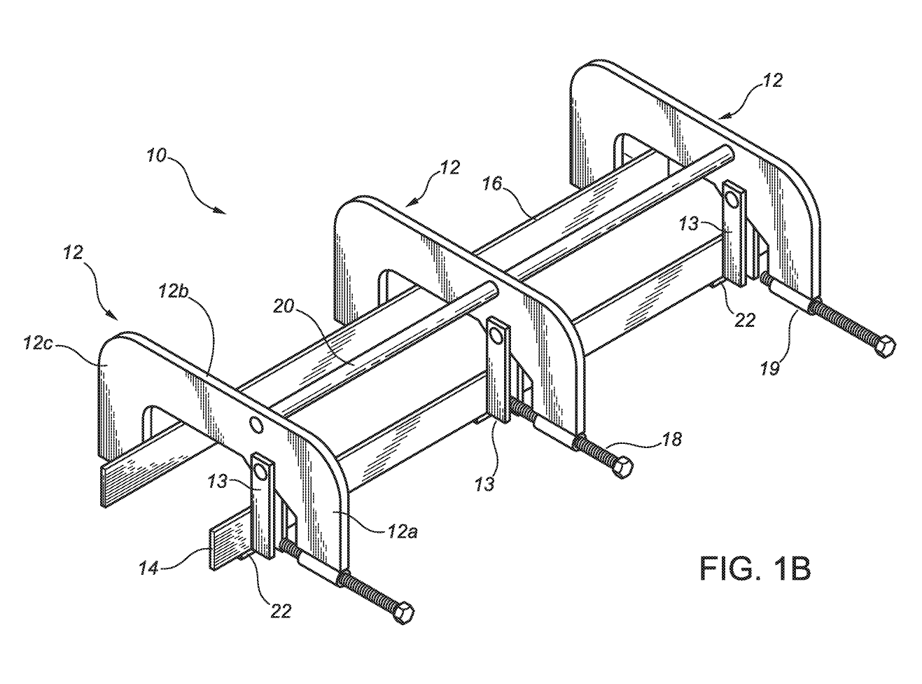

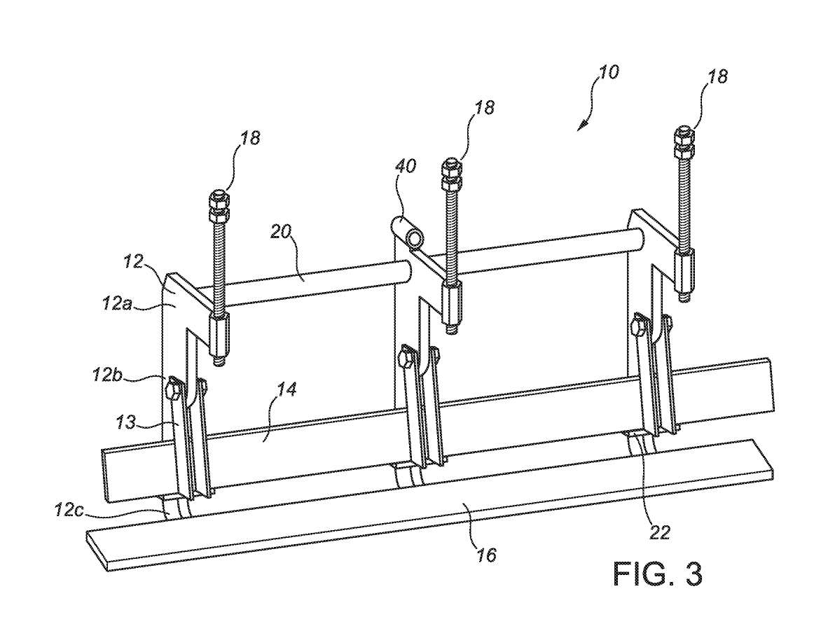

FIGS. 2 and 4 show one embodiment of the present lever clamp in an open position—that is—having bolts 18 disengaged from the press bar 14, and press bar 14 spaced away from base bar 16 such that tank 100 and liner 102 may be received therebetween. As such, lever member, comprising pivoting arm 13 and press bar 14, and base bar 16 operate in combination with bolts 18 to secure the liner 102 to the tank 100 (see FIG. 5).

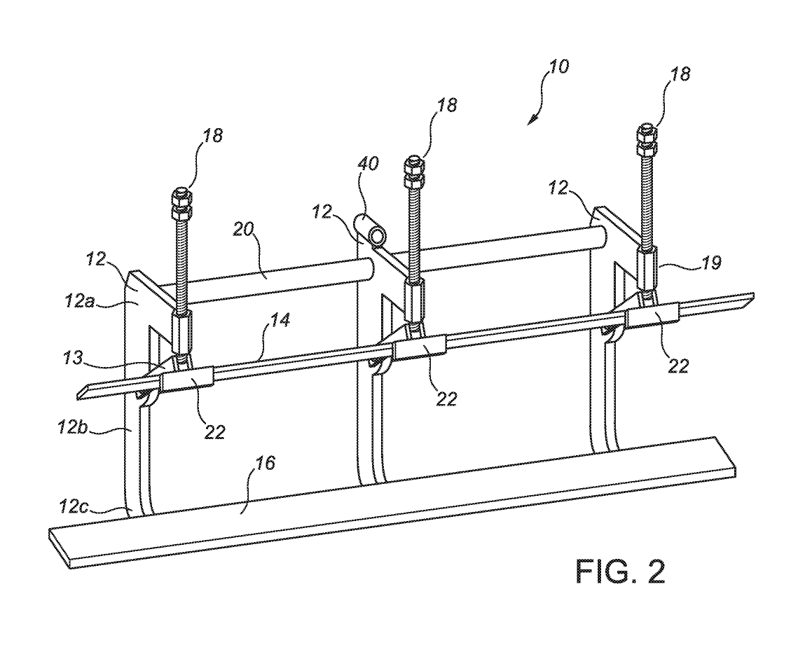

FIGS. 3 and 5 show one embodiment of the present lever clamp in a closed position—that is—having lever member pivoted inwardly towards base bar 16. Having regard to FIG. 3, lever member may be moved pivoted into or out of position independently of bolts 18. As such, the present clamp 10 may be positioned on tank 100 and adjusted in place to ensure accurate clamping of the liner 102 before being any pressure is applied to press bar 14 by bolts 18. Alternatively, the clamp 10 may be positioned in place using minimal pressure from one or more bolts 18, independently from one another, until an accurate position is achieved. Having regard to FIG. 5, once the clamp is in position, bolts 18 may then each be threaded independently of one another and of the press bar 14 to apply pressure and to create a consistent clamping force against base bar 16 (via tank 100 and liner 102 positioned therebetween). It is understood that because bolts 18 may be independently engaged and disengaged, bolts 18 may be used to hold the present clamp 10 in place until an accurate clamping position is achieved (e.g. until consistent clamping forces along longitudinal axis of the press bar 14 is obtained). Where adjustments to the position of the press bar 14 or base bar 16 is required, bolts 18 may be independently retracted and disengaged from press bar 14 and reengaged with minimal effort. It is further understood that the ability to independently engage/disengage one or more bolts can prevent points of weakness and breakage caused by permanent connections between bolts 18 and press bar 14, thereby reducing the need to replace damaged clamps 10, and minimizing slippage of clamps 10 from the tank 100.

It is contemplated that the present clamp 10 may comprise at least two C-shaped members 12 provided in series. Clamp 10 may comprise stabilizing bar 20 for positioning each C-shaped member 12 substantially parallel to one another (see FIG. 1B). Preferably, stabilizing bar 20 may be positioned at or near the upper end 12a of the C-shaped members 12. Stabilizing bar 20 may further increase the rigidity of clamp 10, thereby improving sturdiness.

It is further contemplated that the present lever clamp 10 may comprise a press bar 14 comprising a flange 22 depending downwardly therefrom. Flange 22 may serve to further engage and connect the present clamp 10 to tank 100 (see FIG. 5). The present lever clamp 10 may also comprise a base bar 16 having padding or other gripping means to reduce slippage of the clamp 10 and/or damage to the liner 102.

It is further contemplated that the present lever clamp 10 may comprise attachment means, such as for example rope attachment 40, for securing a net above the tank in order to prevent birds from landing in the tank and/or damaging the lining.

Although some embodiments of the present lever clamp have been shown and described, it will be appreciated by those skilled in the art that various changes and modifications might be made without departing from the scope of the clamp provided. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

1. A lever clamp for securing a liner to a holding tank, the clamp comprising:
at least one C-shaped member capable of slidably receiving the liner and the tank,
a lever member pivotally connected to the at least one C-shaped member,
a base bar in spaced relation and corresponding to the lever member, and
a bolt capable of releasably engaging the lever member to create a clamping force between the lever member and the base bar for securing the liner and the tank positioned therebetween.

2. The clamp of claim 1, wherein the clamp comprises at least two C-shaped members and two bolts.

3. The clamp of claim 2, wherein the two bolts are capable of releasably engaging the lever member independently of one another.

4. The clamp of claim 3, further comprising a stabilizing bar.

5. The clamp of claim 1, where the lever member comprises an arm and a press bar.

6. The clamp of claim 5, wherein the press bar further comprises a flange depending downwardly therefrom.

7. of the lever clamp of claim 1 for securing the liner to a liquid holding tank.
